(19) United States
(12) Patent Application Publication
(10) Pub. No.: US 2006/0245735 A1
(43) Pub. Date: Nov. 2, 2006

(54) Image recording device and method for driving image recording device

(76) Inventors: Masakazu Kanda, Kyoto (JP); Manabu Kuroda, Takaraduka (JP); Kengo Nishimura, Suita (JP); Kunihiko Hayashi, Osaka (JP)

Correspondence Address: MCDERMOTT WILL & EMERY LLP, 600 13TH STREET, N.W., WASHINGTON, DC, 20005-3096, US

(21) Appl. No.: 11/410,919

(22) Filed: Apr. 26, 2006

(30) Foreign Application Priority Data
Apr. 28, 2005 (JP) 2005-133382

(51) Int. Cl. H04N 5/91

(52) U.S. Cl. 386/107

(57) ABSTRACT

Provided are an image recording device having an image quality checking function of previously checking a quality of the image to be replayed when the image is recorded in a recording mode having been set, the image recording device being capable of preventing a circuit size from increasing when the image quality checking function is additionally provided, and capable of preventing power consumption from increasing when the image quality checking function is being performed, and a method for driving the image recording device. When an image quality checking mode starting key of a user interface 3 is operated, a control section 4 causes at least a portion of a data compression unit 51 and a local decoder, which are provided in an encoder 5, to be in driven states. Furthermore, a retrieve/display control section 7 retrieves an image stored in a frame memory 27 and displays the retrieved image. In accordance with an operation of an image quality adjustment button provided in the user interface 3, an encoding parameter for the encoder 5 is to be changed.

### BACKGROUND OF THE INVENTION

1. Field of the Invention

The present invention relates to an image recording device and a method for driving the image recording device.

2. Description of the Background Art

Generally, in a conventional image recording device such as a camcorder, which is nowadays widely used, an image is recorded in accordance with a recording mode selected by a user. A compression rate of a digital image differs depending on the recording mode. That is, when an image is being recorded, the lower a compression rate is, the higher a quality of the image to be replayed becomes. On the other hand, the higher the compression rate is, the smaller the size of recorded image data becomes, whereby a recordable time of a recording medium (i.e., a period of time in which a motion picture can be recorded thereon) is increased. Thus, the user may select the recording mode by taking into consideration of a type and an importance of the image to be recorded, as well as a recording time period.

However, a currently available conventional image recording device does not have a function of previously checking a quality of a replayed image recorded in a recording mode selected by the user. In order to check the quality of the replayed image, the user has to perform a series of operations such as capturing an image to be recorded, specifying recorded image data, and replaying the specified image data. Due to such troublesome operations, it has been a problem in that the user captures an image to be recorded without previously checking a quality thereof, and realizes, when the recorded image is replayed, that the quality of the replayed image is worse than expected.

As a technique for solving the aforementioned problem, Japanese Laid-Open Patent Publication No. 2003-52016 discloses an image recording device (a digital VCR) having a function of previously checking a quality of an image. In the image recording device disclosed therein, when the quality of the image is being checked, an image is captured so as not to be recorded on a recording medium, and recorded image data is temporarily stored in a memory other than the recording medium. Then, the image recording device retrieves the image data from the memory by a predetermined unit, encodes the retrieved data, and decodes the encoded data, thereby obtaining the image data for one frame to be displayed in a display section.

Generally, in an image recording device adopting the MPEG (Motion Picture Experts Group) compression system, a local decoder included in an encoder is shared with a decoder, in order to achieve a smaller size or a lower cost. As described above, in the case where the encoder and the decoder share the common element (i.e., the local decoder), the image recording device cannot perform encoding and decoding simultaneously, whereby encoded data has to be temporarily stored in a recording medium or the like and then retrieved to be decoded. Thus, it takes a long period of time to encode and decode the data, and a control performed for encoding and decoding the data also becomes troublesome. Furthermore, as a period of time required for encoding and decoding the data becomes long, a delay time from when a camera captures an image to when the display section displays the image is accordingly to be long.

In order to shorten the delay time, there may be a case where the encoder and the decoder are provided in a separate manner. In this case, because the encoder and the decoder are operated simultaneously, a processing speed can be improved. Furthermore, in the case where the encoder and the decoder are operated simultaneously, a memory access is unnecessary when encoded data is temporarily stored in the recording medium and then retrieved the encoded data for decoding. Thus, it becomes possible to further shorten a period of time to encode and decode the data. However, in the case where the encoder and the decoder are provided in a separate manner, an effect provided by sharing the common element between the encoder and the decoder (e.g., a reduction of a circuit scale) is no longer maintained. Furthermore, when a quality of an image is being checked, the power consumption needs to be suppressed as much as possible. However, in the case where the encoder and the decoder are operated simultaneously, the power consumption is significantly increased when the quality of the image is being checked.

### SUMMARY OF THE INVENTION

Therefore, an object of the present invention is to provide an image recording device having an image quality checking function of previously checking a quality of a replayed image recorded in a recording mode having been set, the image recording device being capable of preventing a circuit scale from increasing when the image quality checking function is additionally provided, and capable of preventing power consumption from increasing when the image quality checking function is being performed, and a method for driving the image recording device.

A first aspect of the present invention is directed to an image recording device for compressing image data and recording the compressed image data. The image recording device comprising: a photographing section; a display section; an encoder including: a compression unit for compressing the image data outputted from the photographing section; a local decoder for decompressing the image data outputted from a branch point of the compression unit; and a frame memory for storing an image to be read by the compression unit and the local decoder; a user operation section including: an image quality checking mode starting key; and a compression rate adjustment key for adjusting a data compression rate for the compression unit; an encoding parameter setting section for setting an encoding parameter for the encoder in accordance with a state of the compression rate adjustment key; a driven state control section for causing at least a portion preceding the branch point of the compression unit and a portion of the local decoder, which are provided in the encoder, to be in driven states in accordance with a state of the image quality checking mode starting key; and a retrieve/display control section for retrieving the image stored in the frame memory and displaying the retrieved image in the display section.

The compression unit may include a DCT/quantization unit for performing DCT and quantization in the portion preceding the branch point of the compression unit, and a VLC unit for performing VLC in a portion following the branch point of the compression unit, and the local decoder may include a dequantization/IDCT unit for performing a reverse process of that performed by the DCT/quantization unit.

When an image quality checking mode is being performed and an image is not being recorded, the driven state control section may cause portions other than the portion following the branch point of the compression unit, the local decoder and the frame memory, which are provided in the encoder, to be in operation states similar to those in which the image is being recorded.

When the image quality checking mode is being performed and the image is not being recorded, the control section may cause only the portion preceding the branch point of the compression unit and the local decoder, which are provided in the encoder, to be in driven states. In the above case, an image retrieved from the retrieve/display control section is an intra-frame encoded image

The user operation section may include a display method switching key, and the retrieve/display control section may generate one of a first image, containing only the image retrieved from the frame memory, and a second image, containing both of the image retrieved from the frame memory and outputted from the photographing section, and displays the generated image in the display, in accordance with a state of the display method switching key operated when the image quality checking mode is being performed.

The image recording device may further comprise a timer for measuring an elapsed time from a time at which the image quality checking mode starting key is operated to a predetermined time, wherein the retrieve/display control section may retrieve the image stored in the frame memory and display the retrieved image in the display section when the timer measures the elapsed time.

A second aspect of the present invention is directed to a method for driving an image recording device. The method comprises: an encoder including a compression unit for compressing image data captured by a photographing section, a local decoder for decompressing the image data outputted from a branch point of the compression unit, and a frame memory for temporarily storing an image to be read by the compression unit and the local decoder; and a user operation section including an image quality checking mode starting key, the method being capable of compressing the image data captured by the photographing section and recording the compressed image data, the method comprises: a control step of causing at least a portion preceding the branch point of the compression unit and the local decoder, which are provided in the encoder, to be in driven states in accordance with a state of the image quality checking mode starting key; a retrieving step of retrieving an image from the frame memory in accordance with a state of the image quality checking mode starting key; and a display step of displaying the image retrieved from the frame memory in a display section.

When the image quality checking mode is being performed, an image is retrieved from the frame memory and displayed in the display section. Thus, by seeing the image, retrieved from the frame memory and displayed in the display section, which has a quality corresponding to that of an image recorded in a recording mode having been set and then replayed, the user can check and adjust a quality of the image. The image recording device according to the present invention can be configured in a similar manner to the conventional image recording device. Thus, adding a function of checking a quality of an image does not lead to an expansion of a circuit scale.

Furthermore, when the image quality checking mode is performed while an image is not being recorded, only a portion of the compression unit and a portion of the local decoder included in the encoder are driven. Thus, when the image quality checking mode is performed while the image is not being recorded, the power consumption is small. Alternatively, when the image quality checking mode is performed while an image is being recorded, a process of retrieving the FM image and a process of displaying the FM image in the display section are additionally performed. Thus, when the image quality checking mode is performed while the image is being recorded, an increase in the power consumption is small.

The frame memory is a memory for temporarily storing a reference image (i.e., a forward/backward prediction encoded image) used for a motion estimation and a motion compensation. In the case where an image is recorded on a recording medium and then replayed, the conventional image recording device cannot simultaneously display a camera image and the replayed image, both of which represent a same scene. However, the image recording device according to the present invention retrieves and displays an image stored in the frame memory (e.g., a forward prediction encoded image), thereby making it possible to almost simultaneously display the camera image and the retrieved image which has a quality corresponding to that of the replayed image. Therefore, with reference to a quality of the camera image, the user can adjust the quality of the retrieved image by comparing the quality of the retrieved image with that of the camera image.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating an image recording device according to the present invention;

FIG. 2 is an example of an external view of the image recording device shown in FIG. 1;

FIG. 3 is a block diagram more specifically illustrating an exemplary configuration of the image recording device shown in FIG. 1;

FIG. 4 is a diagram illustrating a data transmission path for when an image is not being recorded and an image quality checking mode is not being performed;

FIG. 5 is a diagram illustrating a data transmission path for when an image is not being recorded and the image quality checking mode is being performed;

FIG. 6 is a diagram illustrating another data transmission path for when the image is not being recorded and the image quality checking mode is being performed;

FIG. 7A is a view illustrating an exemplary display image for when the image quality checking mode is being performed;

FIG. 7B is a view illustrating another exemplary display image for when the image quality checking mode is being performed;

FIG. 7C is a view illustrating still another exemplary display image for when the image quality checking mode is being performed;

FIG. 7D is a view illustrating still another exemplary display image for when the image quality checking mode is being performed;

FIG. 8 is a diagram illustrating a data transmission path for when an image is being recorded and the image quality checking mode is not being performed;

FIG. 9 is a diagram illustrating another data transmission path for when the image is being recorded and the image quality checking mode is not being performed;

FIG. 10 is a diagram illustrating a data transmission path for when an image is being recorded and the image quality checking mode is being performed;

FIG. 11 is a diagram illustrating another data transmission path for when the image is being recorded and the image quality checking mode is being performed; and

FIG. 12 is a flowchart illustrating a method for driving the image recording device according to the present invention.

### DESCRIPTION OF THE PREFERRED EMBODIMENTS

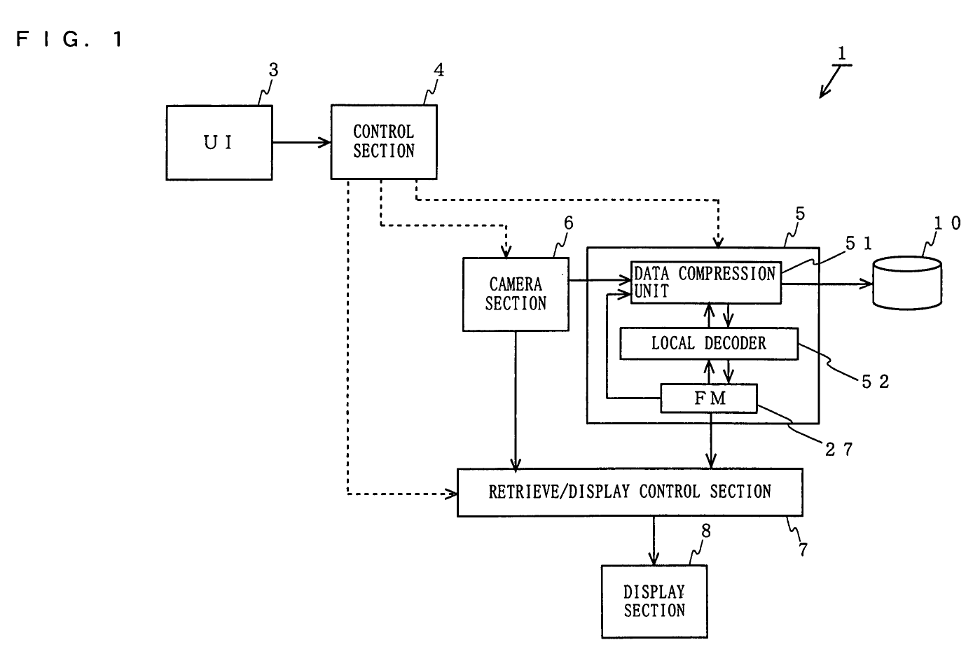

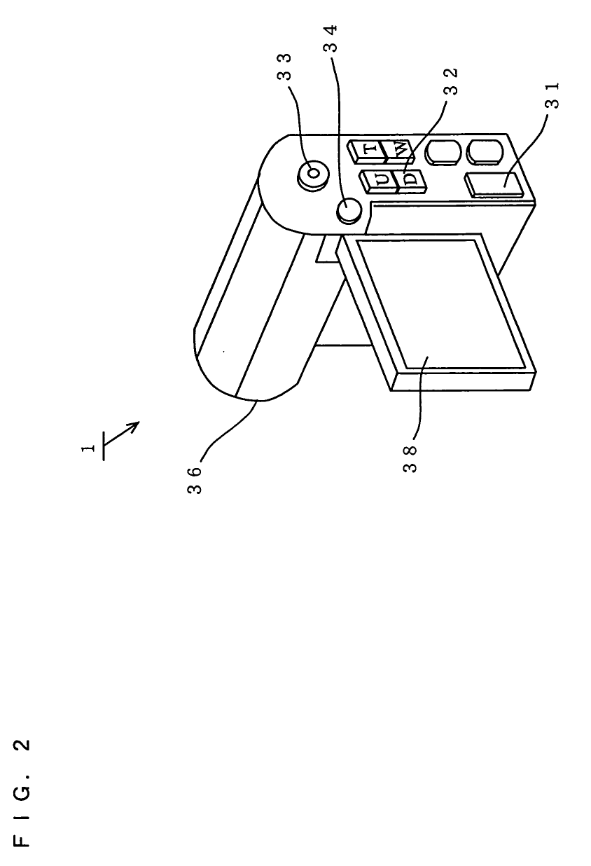

FIG. 1 is a block diagram illustrating an image recording device 1 according to an embodiment of the present invention. FIG. 2 shows an example of an external view of the image recording device 1 in the case where the image recording device 1 is a camcorder. The image recording device 1 shown in FIG. 1 comprises a user interface (UI) 3, a control section 4, a camera section 6, an encoder 5, a retrieve/display control section 7, and a display section 8. The encoder 5 is a section for encoding an image by means of a motion picture compression system such as the MPEG. The encoder 5 includes a data compression unit 51, a local decoder 52, and a frame memory (FM) 27. When an image is being recorded, image data captured by the camera section 6 is compressed by the data compression unit 51, and then stored in a recording medium 10. The local decoder 52 decompresses the image data outputted from a branch point of the data compression unit 51 and outputs the decompressed data. The frame memory 27 is a memory for temporarily storing an image (a reference image) to be read by the data compression unit 51 and the local decoder 52.

The user interface 3 shown in FIG. 1 includes a plurality of operation keys such as a power source button 31, an image quality adjustment button 32, a record button 33, and a display switch button 34, which are shown in FIG. 2. A camera lens 36 and a display screen 38 shown in FIG. 2 are included in the camera section 6 and the display section 8 shown in FIG. 1, respectively. In accordance with operations of the operation keys of the user interface 3, a signal corresponding to one of the operations is inputted to the control section 4. The control section 4 controls the encoder 5, the camera section 6, and the retrieve/display control section 7 based on the inputted signal and a current operation state of each of the encoder 5, the camera section 6, and the retrieve/display control section 7.

The image recording device 1 has an image quality checking mode as a unique function mode. When the image quality checking mode is being performed, an image, captured by the camera section 6, having a quality corresponding to that of an image recorded on the recording medium 10 and then replayed, is displayed in the display section 8. The user operates the image quality adjustment button 32 while checking the quality of the displayed image, thereby re-setting a data compression rate for the encoder 5 so as to obtain a satisfactory quality of the image. Note that the higher a data compression rate is, the smaller the size of recorded image data becomes. On the other hand, the higher the data compression rate is, the lower a quality of a replayed image becomes.

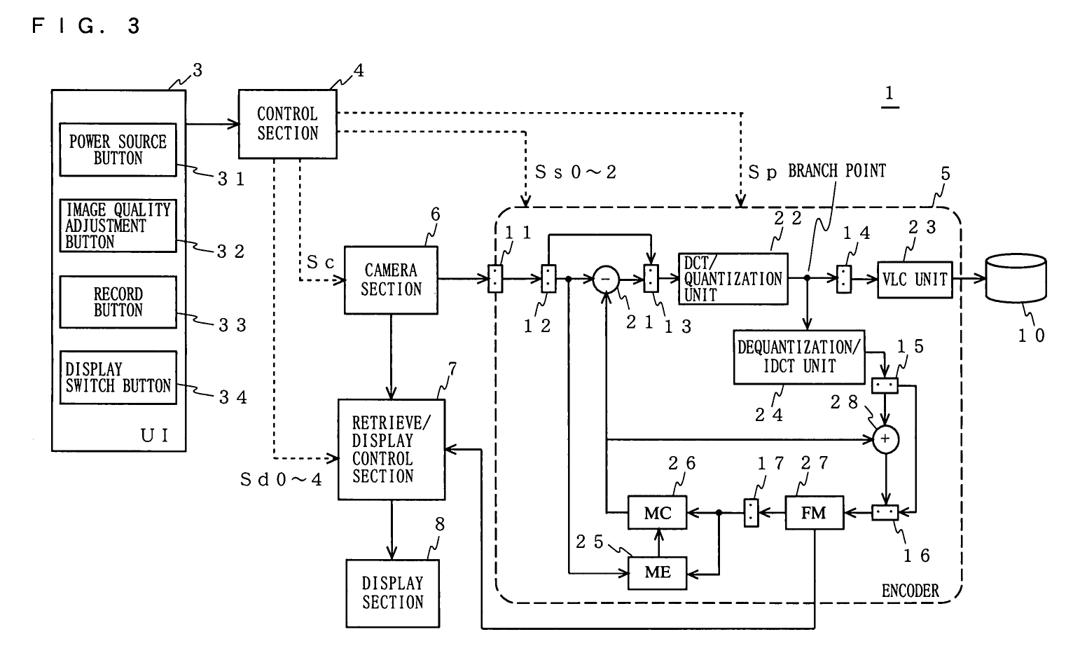

FIG. 3 is a block diagram more specifically illustrating configurations of the user interface 3 and the encoder 5 included in the image recording device 1 shown in FIG. 1. The encoder 5 includes a plurality of selectors 11 to 17 for respectively selecting data transmission paths, a subtractor 21, a DCT (Discrete Cosine Transform)/quantization unit 22, a VLC (Variable Length Coding) unit 23, a dequantization/IDCT (Inverse Discrete Cosine Transform) unit 24, an adder 28, a frame memory 27, a ME (Motion Estimation) unit 25, and a MC (Motion Compensation) unit 26.

In the following description, in a transmission pass from the selector 11 to the VLC unit 23, a portion from the selector 11 to the branch point is referred to as “a portion preceding the branch point”, and a portion from the branch point to the VLC unit 23 is referred to as “a portion following the branch point”.

Among the aforementioned elements in the encoder 5, the subtractor 21, the DCT/quantization unit 22, the VLC unit 23, and the ME unit 25 are included in the data compression unit 51 shown in FIG. 1. More specifically, the subtractor 21 and the DCT/quantization unit 22 are provided in the portion preceding the branch point of the data compression unit 51; and the VLC unit 23 is provided in the portion following the branch point of the data compression unit 51. The dequantization/IDCT unit 24, the adder 28, and the MC unit 26 are provided in the local decoder 52.

The DCT/quantization unit 22 performs two-dimensional DCT on input data divided into blocks of 8×8 pixels, and quantizes the data for which the two-dimensional DCT has been performed, thereby outputting the quantized data. The dequantization/IDCT unit 24 performs a reverse process of that performed by the DCT/quantization unit 22. That is, the dequantization/IDCT unit 24 dequantizes the input data divided into blocks of 8×8 pixels, and performs two-dimensional IDCT on the dequantized data, thereby outputting the data for which the two-dimensional IDCT has been performed. The VLC unit 23 performs variable length coding on the input data, and outputs the data for which the variable length coding has been performed. The encoding parameter for the encoder 5 is set by means of an encoding parameter setting signal Sp out putted from the control section 4 in accordance with an operation of the image quality adjusting button 32.

The ME unit 25 compares an image outputted from the camera section 6 (hereinafter, referred to as a camera image) with an image stored in a predetermined area of the frame memory 27 (hereinafter, referred to as a FM image), and estimates motion between frames of the camera image and the FM image, thereby outputting a motion vector. The MC unit 26 generates a predicted frame image based on the FM image and the motion vector outputted from the ME unit 25, and outputs the predicted frame image. The subtractor 21 calculates a difference between the camera image and the predicted frame image, and outputs the difference therebetween. The adder 28 obtains image data (an image for one frame) by adding the predicted frame image to an output of the dequantization/IDCT unit 24, and outputs the obtained image data.

The control section 4 includes a function of determining a current operation state of the image recording device 1, and a function of controlling a driven state of each of the elements 5 to 7. Specifically, when a signal is outputted from the user interface 3, the control section 4 determines the current operation state of the image recording device 1, such as whether or not an image is being recorded, or whether or not an image quality checking mode is being performed. Then, the control signal 4 outputs one of control signals Ss0 to Ss2 to the encoder 5, for example. In accordance with one of the control signals Ss0 to Ss2, the selectors 11 to 17 are operated (i.e., a data transmission path is switched) such that the driven state of each of the elements 22 to 26 in the encoder 5 is changed.

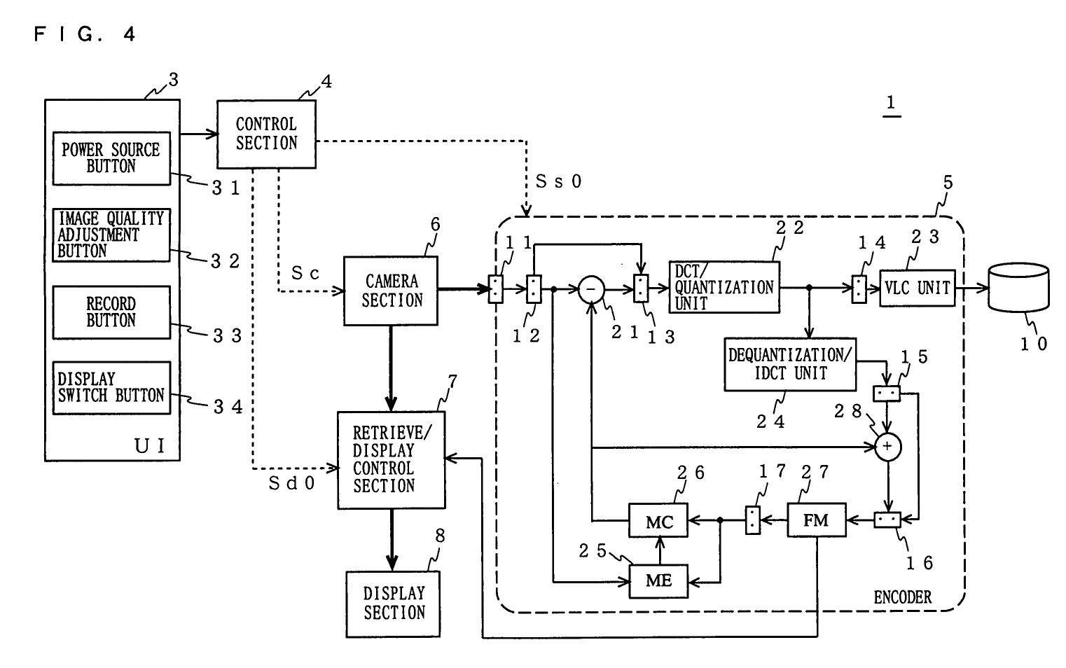

Hereinafter, referring to FIGS. 4 to 11, specific examples of operations performed by the respective elements and transmission paths through which image data are transmitted will be described in the following cases: (1) when an image is not being recorded and an image quality checking mode is not being performed; (2) when an image is not being recorded and the image quality checking mode is being performed; (3) when an image is being recorded and the image quality checking mode is not being performed; and (4) when an image is being recorded and the image quality checking mode is being performed.

(1) When an image is not being recorded and an image quality checking mode is not being performed:

In FIG. 4, a transmission path, through which image data is transmitted when an image is not being recorded and the image quality checking mode is not being performed, is indicated by a bold line. When power is turned on, the control section 4 outputs a photographing signal Sc, a control signal Ss0, and a display signal Sd0 (a display signal for displaying the camera image) to the camera section 6, the encoder 5, and the retrieve/display control section 7, respectively. In accordance with the outputted signals, the camera section 6 starts to capture an image. The control section 4 causes the selector 11 not to input the camera image to the encoder 5, and the control section 4 causes each of the elements 22 to 26 in the encoder 5 to be in an undriven state. The retrieve/display control section 7 outputs the camera image outputted from the camera section 6 to the display section 8.

(2) when an image is not being recorded and the image quality checking mode is being performed:

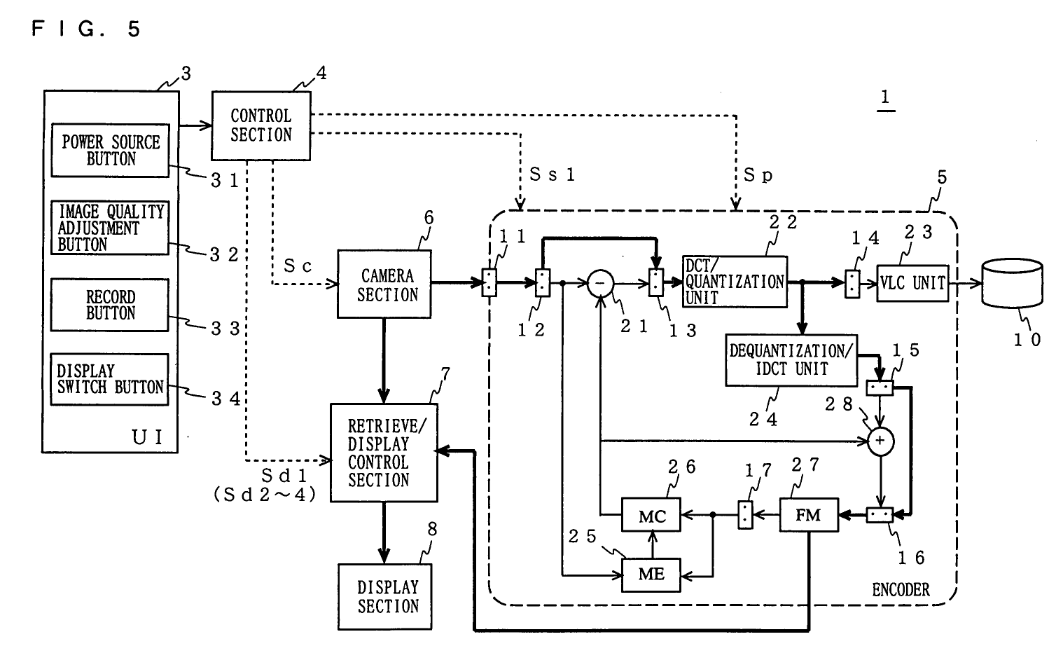

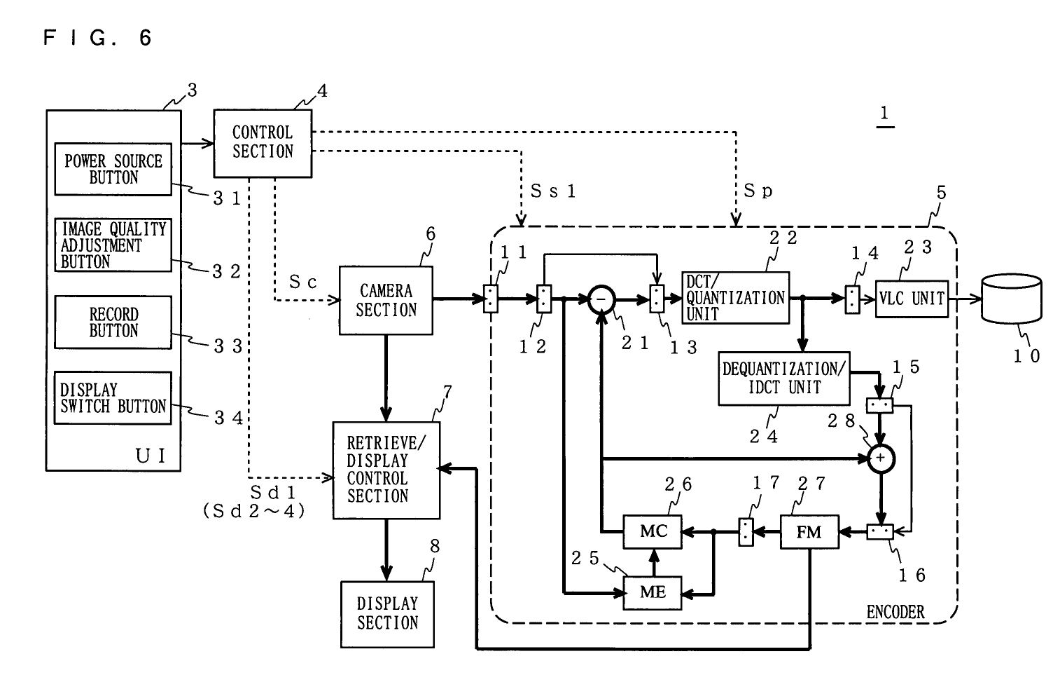

In each of FIGS. 5 and 6, a transmission path, through which the image data is transmitted when an image is not being recorded and the image quality checking mode is being performed, is indicated by a bold line. When the image quality adjustment button 32 is operated in a state shown in FIG. 4 (when an image is not being recorded and the image quality checking mode is not being performed), the control section 4 outputs a control signal Ss1 (a control signal outputted when the image is not being recorded and the image quality checking mode is being performed) and a display signal Sd1 (a display signal for displaying the FM image) to the encoder 5 and the retrieve/display control section 7, respectively. In accordance with the outputted signals, the image quality checking mode starts to be performed when the image is not being recorded.

When the image quality checking mode is performed while an image is not being recorded, e.g., before recording an image, the control section 4 causes each of the elements, other than the VLC unit 23, which are included in the encoder 5, to be in a driven state which is similar to that in which an image is being recorded. Specifically, as shown in FIG. 5, when an intra-frame encoded image (I-picture) is being generated, each of the elements 22 to 26 and each of the selectors 11 to 17 are controlled such that the DCT/quantization unit 22 and the dequantization/IDCT unit 24 are to be in driven states; the MC unit 26, the ME unit 25, and the VLC unit 23 are to be in undriven states; and the subtractor 21 and the adder 28 are not to substantially function. As shown in FIG. 6, when an inter-frame forward prediction encoded image (P-picture) and an inter-frame bidirectional prediction encoded image (B-picture) are being generated, each of the elements 22 to 27 and each of the selectors 11 to 17 are controlled such that the DCT/quantization unit 22, the dequantization/IDCT unit 24, the MC unit 26, and the ME unit 25 are to be in driven states; the VLC unit 23 is to be in an undriven state; and the subtractor 21 and the adder 28 are to function.

Note that in the case where the subtractor 21 and the adder 28 are caused to not substantially function, each of the selectors 12 to 16 may be controlled, as shown in FIG. 5, so as not to input data to the subtractor 21 and the adder 28, or the data may be inputted to the subtractor 21 and the adder 28 so as to subtract and add zero, respectively.

When the image quality checking mode is being performed, the retrieve/display control section 7 retrieves an image (FM image) stored in the frame memory 27 so as to coincide with a timing at which the encoder 5 generates a picture, and outputs the retrieved image to the display section 8. When the elements, provided in the encoder 5, which are not included in the portion following the branch point of the data compression unit 51 (the VLC unit 23), are controlled in a similar manner to the case where an image is being recorded, an image displayed in the display section 8 is a local decode image including the I-picture and the P-picture.

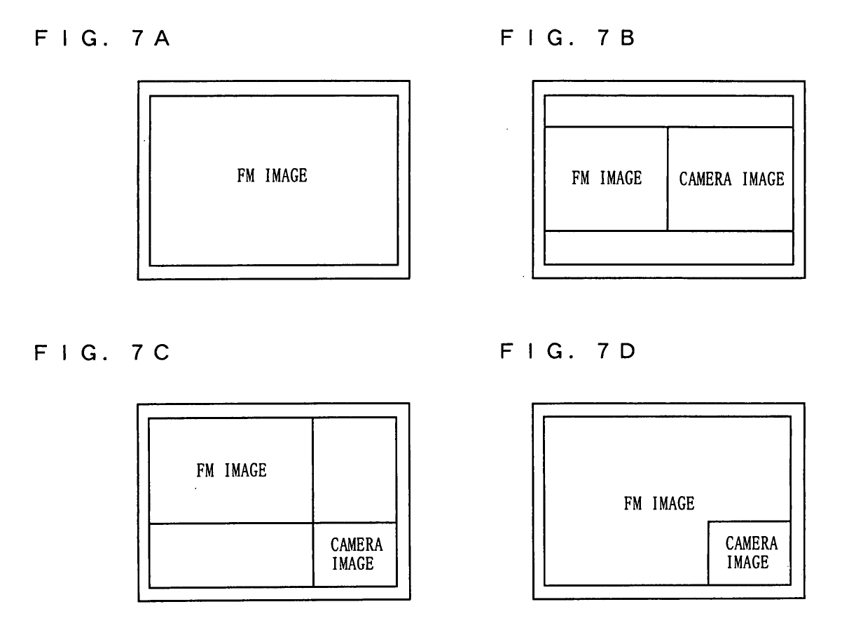

Each of FIGS. 7A to 7D shows an exemplary display image obtained when the image quality checking mode is being performed. When the image quality checking mode is being performed, at least the FM image is displayed in the display section 8. However, when the image quality checking mode is being performed, the camera image may be displayed together with the FM image in the display section 8. In the case where a display method can be selected from among a plurality of the display methods, the display section 8 outputs one of different display signals Sd1 to Sd4 in accordance with a total number of times at which the display switching button 34 is operated, such that an image processing method performed by the retrieve/display control section 7 is changed in accordance with the outputted signal.

More specifically, for example, in accordance with the display switching button 34 operated at the (4n-3)th, the (4n-2)th, the (4n-1)th and the (4n)th time (n is a natural number) including a time at which the image quality checking mode is started, the control section 4 outputs the display signals Sd1, Sd2, Sd3, and Sd4, which correspond to FIG. 7A, FIG. 7B, FIG. 7C, and FIG. 7D, respectively.

When the image quality checking mode is being performed, the encoding parameter can be adjusted by operating the image quality adjustment button 32. Thus, the user can adjust a quality of an image by operating the image quality adjustment button 32, while seeing the quality of the image displayed in the display section 8. The control section 4 outputs the encoding parameter setting signal Sp in accordance with the image quality adjustment button 32 operated by the user, and the encoding parameter for the encoder 5 is changed in accordance with the outputted signal Sp. When the encoding parameter is changed, a compression rate for the encoder 5 accordingly changes. Note that the encoding parameter includes a quantization parameter for determining a quantization step size when quantization is to be performed.

As described above, according to the image recording device 1, a quality of a replayed image recorded in a given recording mode (a compression rate) can be previously checked before recording the image. In the case where an image is recorded on the recording medium 10 and then replayed, VLC (Variable Length Coding) and VLD (Variable Length Decoding) are performed for the image. On the other hand, VLC and LVD are not performed for the FM image. However, because VLC is a reversible compression process, a quality of an image for which VLC and LVD are performed is the same as that of an image for which VLC and LVD are not performed. Furthermore, a large amount of power is consumed when VLC and VLD are being performed. Thus, it is advantageous that the power consumption can be substantially reduced when VLC and VLD are not performed.

In an image recording device in which the B-picture is additionally generated and recorded, a frame rate of the FM image (the local decode image) displayed when the image quality checking mode is being performed is lower than that of an image actually recorded and then replayed. That is, frame dropping occurs when the B-picture is being displayed in the display section 8. Therefore, a movement of the displayed image may be less smooth than that of the image recorded and then replayed. However, in the image recording device 1, some factors which determine a quality of an image and are not pertinent to a frame rate (e.g., resolution) can be checked to be adjusted.

Therefore, in the aforementioned image recording device in which the B-picture is additionally generated and recorded, when an image is not being recorded and the image quality checking mode is being performed, the respective elements in the encoder 5 may be always controlled as shown in FIG. 5. In the above case, the frame rate is not reduced, and a motion picture generated only from a plurality of successive I-pictures is displayed in the display section 8. Note that the displayed motion picture is not completely identical to an image recorded on the recording medium 10 and then replayed. However, the displayed motion picture is not significantly different from the image recorded on the recording medium 10 and then replayed. Thus, it is sufficiently possible to use this motion picture as an image for previously checking a quality thereof. When the aforementioned motion picture is used as an image for previously checking a quality of an image, the VLC unit 23, the MC unit 26, and the ME unit 25 are not driven, thereby making it possible to further reduce the power consumption. When an image is not being recorded and the image quality checking mode is being performed, a method of checking a quality of an image may be switched by means of the operation buttons of the user interface 3 operated by the user.

Alternately, in the aforementioned image recording device in which the B-picture is additionally generated and recorded, when an image is not being recorded and the image quality checking mode is being performed, the encoder 5 may be controlled such that the B-picture is not to be generated (i.e., only the I-picture and the P-picture are to be generated), thereby obtaining the FM image having a quality closer to that of a recorded image than that of the FM image generated only from the I-picture.

(3) when an image is being recorded and the image quality checking mode is not being performed:

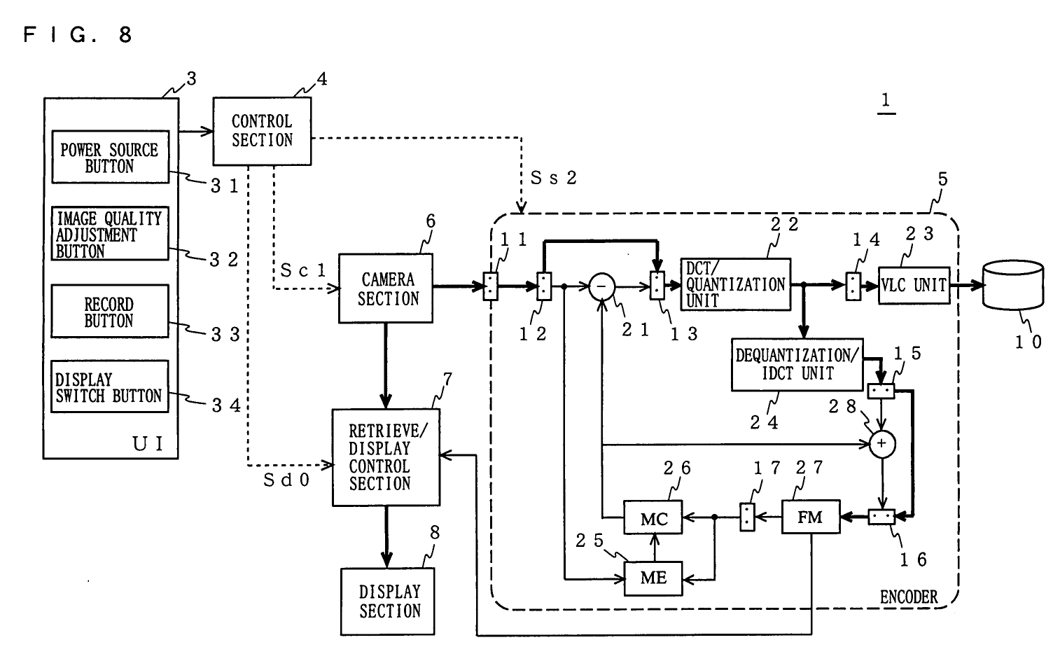

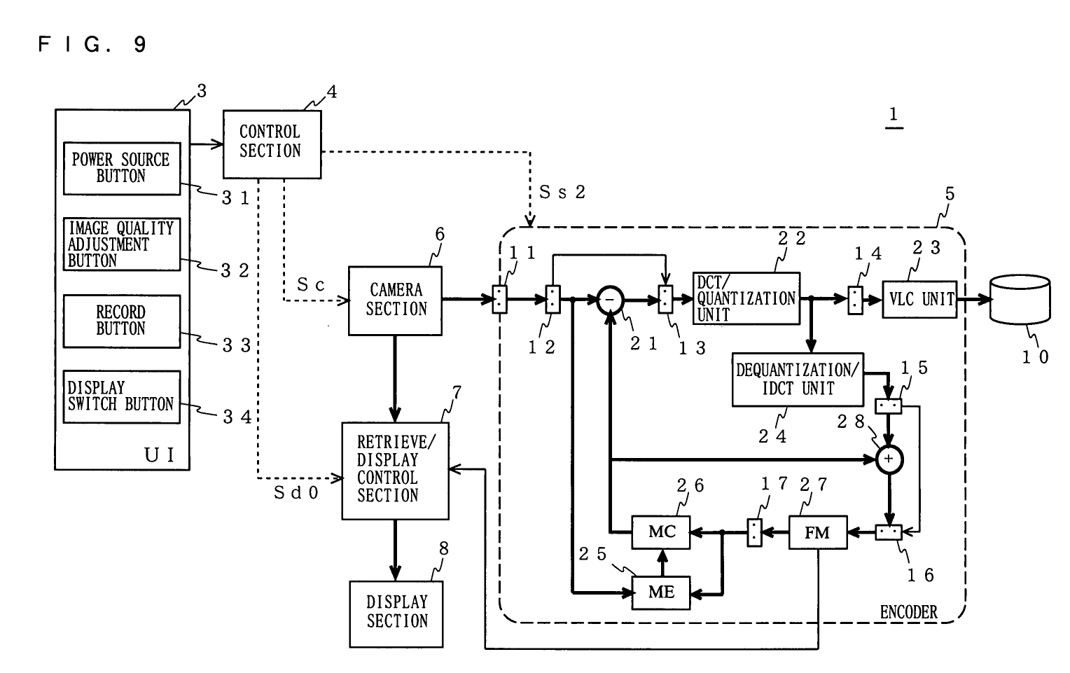

In each of FIGS. 8 and 9, a transmission path, through which the image data is transmitted when an image is being recorded and the image quality checking mode is not being performed, is indicated by a bold line. When the record button 33 is turned on while the power is on, the control section 4 outputs a control signal Ss2 (a control signal outputted when an image is being recorded) and the display signal Sd0 (the display signal for displaying the camera image) to the encoder 5 and the retrieve/display control section 7, respectively. In accordance with the outputted signals, an image starts to be recorded.

Specifically, as shown in FIG. 8, when the I-picture is being generated, each of the elements 22 to 26 and each of the selectors 11 to 17 are controlled such that the DCT/quantization unit 22, the VLC unit 23, and the dequantization/IDCT unit 24 are to be in driven states; the MC unit 26 and the ME unit 25 are to be in undriven states; and the subtractor 21 and the adder 28 are not to substantially function.

As shown in FIG. 9, when the P-picture and the B-picture are being generated, each of the elements 22 to 27 and each of the selectors 11 to 17 are controlled such that the DCT/quantization unit 22, the VLC unit 23, the dequantization/IDCT unit 24, the MC unit 26, and the ME unit 25 are to be in driven states; and the subtractor 21 and the adder 28 are to function. In both cases where the I-picture only is being generated and where the B-picture and the P-picture are being generated, an output of the DCT/quantization unit 22 is inputted to the VLC unit 23, and a bit stream outputted from the VLC unit 23 is finally stored in the recording medium 10. When an image is being recorded and the image quality checking mode is not being performed, the FM image is not retrieved, and the camera image is displayed in the display section 8.

(4) when an image is being recorded and the image quality checking mode is being performed:

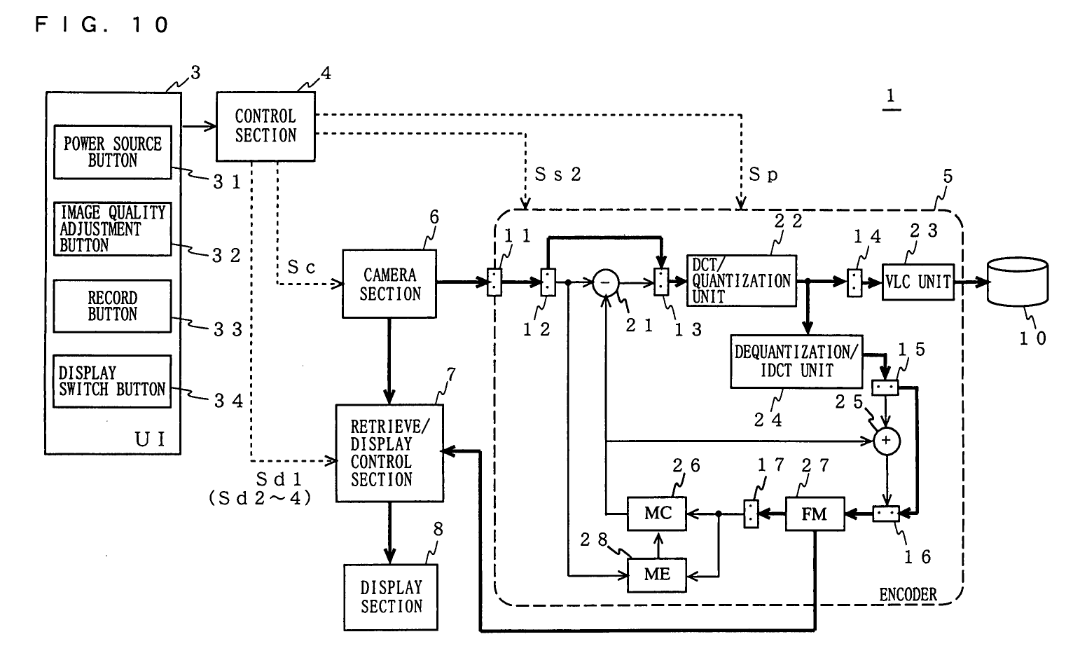

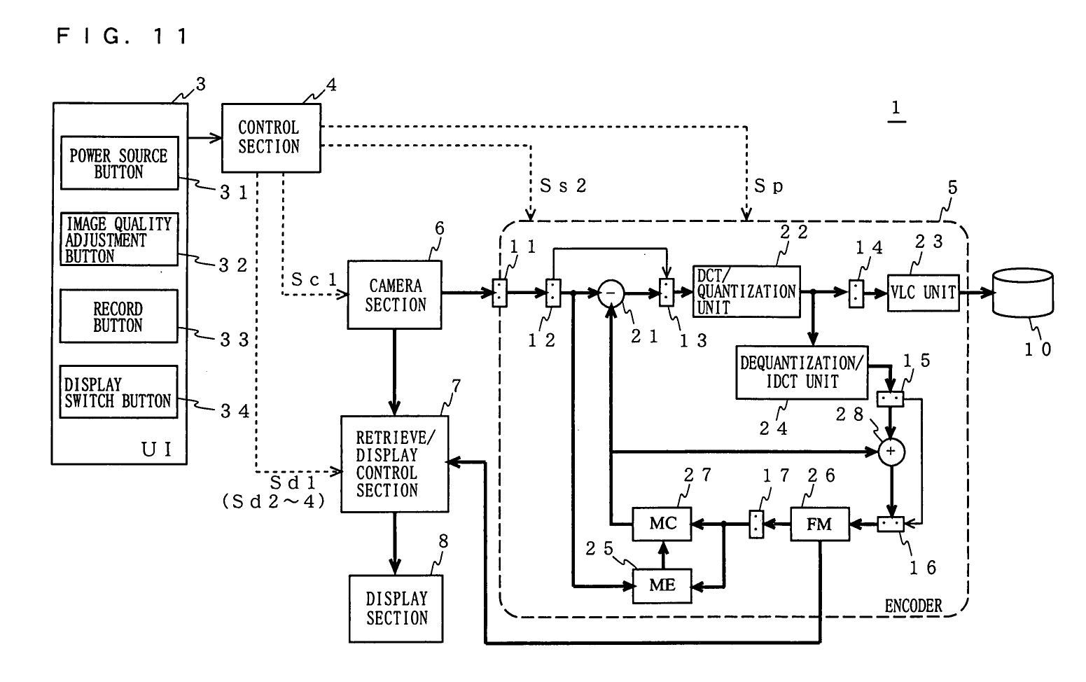

In each of FIGS. 10 and 11, a transmission path, through which the image data is transmitted when an image is being recorded and the image quality checking mode is being performed, is indicated by a bold line. When the image quality adjustment button 32 is operated while an image is being recorded, or at a time when an image starts to be recorded, the control section 4 outputs the control signal Ss2 (the control signal outputted when an image is being recorded) and the display signal Sd1 (the FM image signal for displaying the FM image) to the encoder 5 and the retrieve/display control section 7, respectively. In accordance with the outputted signals, the image quality checking mode starts to be performed when the image is being recorded. When the image quality checking mode is being performed, the retrieve/display control section 7 retrieves an image stored in the frame memory 27, and outputs the retrieved image to the display section 8. Furthermore, when an image is being recorded and the image quality checking mode is being performed, the encoder 5 is controlled in a similar manner to the aforementioned case where the image is being recorded and the image quality checking mode is not being performed. Still furthermore, similarly to the case where the image is not being recorded and the image quality checking mode is being performed, when an image is being recorded and the image quality checking mode is being performed, an operation can be carried out by means of the image quality adjustment button 32 and the display switching button 34.

The image quality checking mode may be set so as to be performed in conjunction with a time at which an image starts to be recorded by means of the record button 33 operated by the user. Alternatively, only when the image quality checking mode is not performed before recording an image, the image quality checking mode may be set so as to be performed in conjunction with the time at which the image starts to be recorded.

The image quality checking mode may be set so as to be finished when a predetermined time has passed since the image quality adjustment button 32 or the record button 33 is operated, thereby making it possible to reduce an operation, performed by the user, for finishing the image quality checking mode. Furthermore, if the image quality checking mode may be set in the above-mentioned manner, the encoder 5 can be stopped even before an operation is performed by the user, thereby making it possible to suppress the power consumption. In the case where the image quality checking mode is set as such, when the image quality adjustment button 32 is operated (so as to start the image quality checking mode or adjust a quality of an image) or the record button 33 is operated, the control section 4 may cause the respective elements in the encoder 5 to be in states in which the image quality checking mode is being performed, and cause a timer to start measuring a time. When a predetermined time passes, the control section 4 may cause the respective elements in the encoder 5 to return to states in which the image quality checking mode is not being performed.

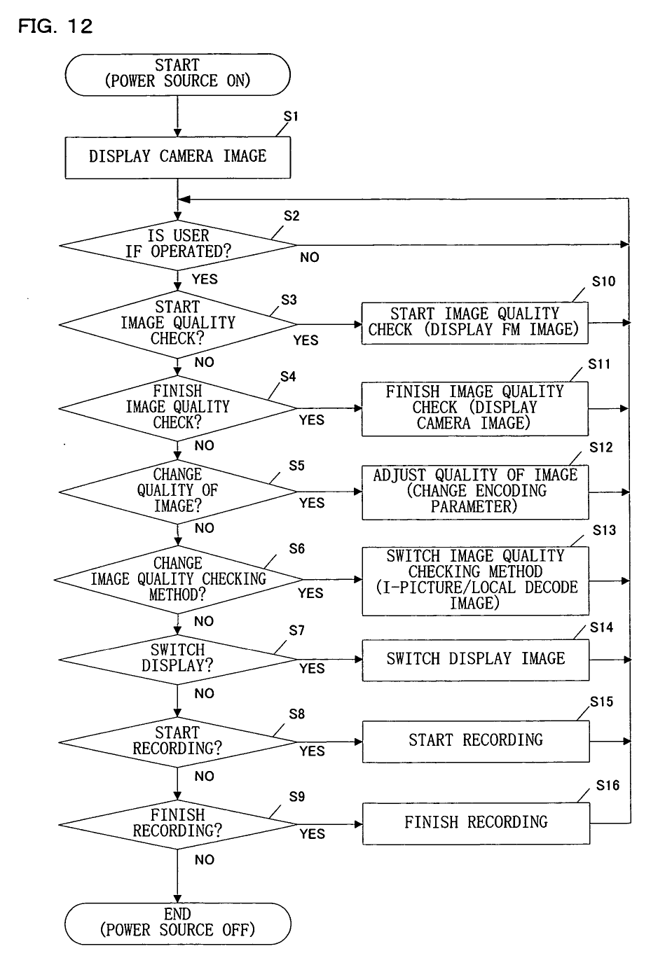

FIG. 12 is a flowchart illustrating an operation and a control of the image recording device 1. When the power is turned on, the camera image is displayed in the display section 8 (step S1), and the image recording device 1 is to be in a state of waiting for an instruction from the user. Then, if the user operates the user interface 3 until the power is turned off (Yes in step S2), the image recording device 1 is controlled in accordance with the user interface 3 operated by the user.

Specifically, when an image quality checking mode starting button is operated (Yes in step S3), the image quality checking mode is to be performed. When the image quality checking mode is being performed, because the encoder 5 is controlled so as to be in a predetermined driven state, the FM image is retrieved from the frame memory 27. Therefore, an image containing the FM image is displayed in the display section 8 (step S10). Note that the image quality checking mode starting button may not be individually provided. The image quality checking mode starting button may be the image quality adjustment button 32 or the record button 33. When an image quality checking mode finishing button (not shown) is operated or the predetermined time has passed since an operation, such as checking a quality of an image, is performed, the image quality checking mode is to be finished (Yes in step S4), and the camera image is to be displayed in the display section 8.

When the image quality adjustment button 32 is operated (Yes in step S5), the encoding parameter is to be changed so as to accordingly change a compression rate for the encoder 5 (step S12), thereby changing a quality of an image displayed in the display section 8.

When an image quality checking method switching button is operated while the image quality checking mode is being performed (step S6), a control method performed by the encoder 5 is to be switched. For example, in the case where the local decode image is displayed as the FM image before the control method is switched, the control method performed by the encoder 5 is to be switched so as to display, for example, the I-picture as the FM image.

When the display switching button 34 is operated (Yes in step S7), an image containing the FM image is to be displayed in the display section 8 by means of a display method other than a currently used display method (step S14). When a record starting button (the record button 33) is operated (Yes in step S8), the respective elements in the encoder 5 are to be controlled so as to be in driven states in which an image is being recorded, thereby causing the image recording device 1 to start recording the image on the recording medium 10. When a record finishing button (the record button 33) is operated (Yes in step S9), the respective elements in the encoder 5 are to be controlled so as to be in undriven states, thereby causing the image recording device 1 to finish recording the image. Thereafter, when the power source button 31 is operated (No in step S9), the power is to be turned off.

As described above, when the image quality checking mode is being performed, an image is retrieved from the frame memory 27 and displayed in the display section 8. Therefore, by seeing the image, retrieved from the frame memory 27 and displayed in the display section 8, which has a quality corresponding to that of an image recorded in a recording mode having been set and then replayed, the user can check and adjust a quality of the image. Because the image recording device 1 can be configured in a similar manner to the conventional image recording device, adding a function of checking a quality of an image does not lead to an expansion of a circuit scale.

In the case where the image quality checking mode is performed while an image is not being recorded, only a portion of the data compression unit 51 and a portion of the local decoder 52, which are provided in the encoder 5, are driven. Thus, when the image quality checking mode is performed while the image is not being recorded, the power consumption is small. Alternatively, in the case where the image quality checking mode is performed while an image is being recorded, a process of retrieving the FM image and a process of displaying the FM image in the display section 8 are additionally performed. Thus, when the image quality checking mode is performed while the image is being recorded, an increase in the power consumption is small.

Furthermore, in the case where an image is recorded on a recording medium and then replayed, the conventional image recording device cannot simultaneously display the camera image and the replayed image, both of which represent a same scene. However, in the image recording device 1, an image stored in the frame memory (e.g., a forward prediction encoded image) is retrieved and displayed, thereby making it possible to almost simultaneously display the camera image and the retrieved image which has a quality corresponding to that of the replayed image. Therefore, with reference to a quality of the camera image, the user can adjust the quality of the retrieved image by comparing the quality of the retrieved image with that of the camera image.

Note that a decoder is not described above. However, the image recording device 1 according to the present invention may comprise the decoder for decoding encoded image data stored in the recording medium 10. It is possible to design the image recording device such that the dequantization/IDCT unit 24 included in the encoder 5 is shared with the decoder. Furthermore, processes performed by the control section 4, the encoder 5, and the retrieve/display control section 7, which are all described above, may be performed by hardware or software.

The present invention is applicable to an image recording device, such as a camcorder, for compressing captured image data and recording the compressed image data.

While the invention has been described in detail, the foregoing description is in all aspects illustrative and not restrictive. It is understood that numerous other modifications and variations can be devised without departing from the scope of the invention.

What is claimed is:

1. An image recording device for compressing image data and recording the compressed image data, comprising:
a photographing section;
a display section;
an encoder including:
a compression unit for compressing the image data outputted from the photographing section;
a local decoder for decompressing the image data outputted from a branch point of the compression unit; and
a frame memory for storing an image to be read by the compression unit and the local decoder;
a user operation section including:
an image quality checking mode starting key; and
a compression rate adjustment key for adjusting a data compression rate for the compression unit;
an encoding parameter setting section for setting an encoding parameter for the encoder in accordance with a state of the compression rate adjustment key;
a driven state control section for causing at least a portion preceding the branch point of the compression unit and a portion of the local decoder, which are provided in the encoder, to be in driven states in accordance with a state of the image quality checking mode starting key; and
a retrieve/display control section for retrieving the image stored in the frame memory and displaying the retrieved image in the display section.

2. The image recording device according to claim 1, wherein
the compression unit includes
a DCT/quantization unit for performing DCT and quantization in the portion preceding the branch point of the compression unit, and
a VLC unit for performing VLC in a portion following the branch point of the compression unit, and
the local decoder includes
a dequantization/IDCT unit for performing a reverse process of that performed by the DCT/quantization unit.

3. The image recording device according to claim 1, wherein
when an image quality checking mode is being performed and an image is not being recorded, the driven state control section causes portions other than a portion following the branch point of the compression unit, the local decoder and the frame memory, which are provided in the encoder, to be in operation states similar to those in which the image is being recorded.

4. The image recording device according to claim 3, wherein
when the image quality checking mode is being performed and the image is not being recorded, an image retrieved from the retrieve/display control section is a local decode image including an intra-frame encoded image and an inter-frame forward prediction encoded image.

5. The image recording device according to claim 1, wherein
when the image quality checking mode is being performed and the image is not being recorded, the control section causes only the portion preceding the branch point of the compression unit and the local decoder, which are provided in the encoder, to be in driven states.

6. The image recording device according to claim 5, wherein
an image retrieved from the retrieve/display control section is an intra-frame encoded image.

7. The image recording device according to claim 1, wherein
the user operation section includes a display method switching key, and
the retrieve/display control section generates one of a first image, containing only the image retrieved from the frame memory, and a second image, containing both of the image retrieved from the frame memory and outputted from the photographing section, and displays the generated image in the display section, in accordance with a state of the display method switching key operated when the image quality checking mode is being performed.

8. The image recording device according to claim 1, further comprising a timer for measuring an elapsed time from a time at which the image quality checking mode starting key is operated to a predetermined time, wherein
the retrieve/display control section retrieves the image stored in the frame memory and displays the retrieved image in the display section when the timer measures the elapsed time.

9. A method for driving an image recording device which comprises: an encoder including a compression unit for compressing image data captured by a photographing section, a local decoder for decompressing the image data outputted from a branch point of the compression unit, and a frame memory for temporarily storing an image to be read by the compression unit and the local decoder; and a user operation section including an image quality checking mode starting key, and the method being capable of compressing the image data captured by the photographing section and recording the compressed image data, the method comprising:
a control step of causing at least a portion preceding the branch point of the compression unit and the local decoder, which are provided in the encoder, to be in driven states in accordance with a state of the image quality checking mode starting key;
a retrieving step of retrieving an image from the frame memory in accordance with a state of the image quality checking mode starting key; and
a display step of displaying the image retrieved from the frame memory in a display section.
